(19) United States
(12) Patent Application Publication
(10) Pub. No.: US 2015/0198931 A1
(43) Pub. Date: Jul. 16, 2015

(54) APPARATUS FOR LIMITING INTERPHASE CURRENT AND LEAKAGE CURRENT OF FLOODED ELECTRICAL INSTALLATIONS

(71) Applicant: VISION TECH INC., Busan (KR)

(72) Inventor: Ho Seok LEE, Busan (KR)

(73) Assignee: VISION TECH INC., Busan (KR)

(21) Appl. No.: 14/529,664

(22) Filed: Oct. 31, 2014

(30) Foreign Application Priority Data
Jan. 16, 2014 (KR) 10-2014-0005658

(51) Int. Cl. G05B 9/02; H02H 9/00

(52) U.S. Cl. CPC G05B 9/02; H02H 9/00

(57) ABSTRACT

An apparatus for limiting an interphase current and a leakage current of flooded electrical installations. More specifically, provided is the apparatus, when electrical installations are flooded in water, vapor, and other liquids which have high electrical conductivity, for preventing the electrical installations from being damaged after an interphase current, between both power lines in the electrical installations, rapidly increases through the liquids with high electrical conductivity, or preventing an electric shock accident by limiting a leakage current flowing into the earth through the liquid on both power lines.

To this end, the apparatus provides a phase wire portion, an insulation barrel, a barrel-shaped wire, and a housing ground.

### CROSS-REFERENCE TO RELATED APPLICATION(S)

This application claims the benefit under 35 U.S.C. §119(a) of Korean Patent Application No. 10-2014-0005658, filed on Jan. 16, 2014, in the Korean Intellectual Property Office, the entire disclosure of which is incorporated herein by reference for all purposes.

### BACKGROUND

1. Field

The following description relates to an apparatus for limiting interphase current and leakage current of flooded electrical installations. More specifically, provided is the apparatus for, when electrical installations are flooded in water, vapor, and other liquids which have high electrical conductivity, preventing the electrical installations from being damaged after an interphase current between both power lines in the electrical installations rapidly increases through the liquids with high electrical conductivity, or preventing an electric shock accident by limiting a leakage current flowing into the earth through the liquid on both power lines.

2. Description of the Related Art

An electric shock is a phenomenon in which a human body reacts when an electric current flowing through a human body from the electric power into the earth, which is a ground plane, is greater than a predetermined value. Generally, more than 10 mA of a commonly used alternating current (AC) may cause a human body to have cramps, and more than 30 mA may cause death. The main cause of death is a heart attack indicating that a heart stops functioning as an electric current flowing through a heart damages nerves. The danger of the electric shock is related to a human body's resistance at the moment when an electric current is applied, which greatly depends on a skin condition.

When electrical installations, e.g., an outlet, an electric heater, or an electric lamp, are immersed in water, if a human body contacts the water or a metal housing to which an electric current is applied through the water, an electric current flows from the conductor, exposed to the water, of the electrical installations to the earth, which is a ground plane, through the water and the human body. At that moment, the human body's skin easily gets wet from rain, and in such a case, has extremely low contact resistance, thus being in a very dangerous state.

A short circuit between power lines is caused from problems of an electric current flowing rapidly and device damage, such as fire or a short circuit, if an insulation degree between two lines becomes low and the electrical conductivity becomes high. Generally, since air's conductivity is extremely high, an electrical insulation is maintained treating air between the two lines as a medium. However, if a liquid with high electrical conductivity is filled between the two lines because of the flooding, etc., an interphase current rapidly increases causing a short circuit.

Korean Patent Publication No. 2005-0037986 publicized on Apr. 25, 2005 discloses an apparatus for preventing an electric shock caused by immersion, in case of attaching a metal plate or a metal mesh of metal materials to the exposed charging part and immersing it, to enable an electric current leaking in the exposed charging part to be applied to a conductive metal plate or a metal mesh, so that an electric shock accident is prevented. The metal plate or the metal mesh is connected to a neutral wire and an earth terminal with electric wires among terminal blocks. A size of the metal plate is roughly 50 cm×30 cm.

Although its principle is not described in detail, the Korean Patent Publication No. 2005-0037986 discloses disposing a metal plate to be in a state where resistance between the flooded conductors can be much lower than the resistance between water and the human body when being flooded, and forming the metal plate electrically in parallel with the human body, so as to limit the current that flows into the human body. However, such a metal plate or a metal mesh cannot shield an electric field generated in a radiation form in an exposed charging part, thus it may not be capable of blocking a leakage current effectively and causing a generation of spatial restriction in installation. In addition, the Korean Patent Publication No. 2005-0037986 discloses the leakage current but not interphase current.

Korean Patent Registration No. 1197414 publicized on Nov. 5, 2012 discloses another apparatus for preventing a leakage current. The disclosed apparatus includes: a connection terminal block where first and second connection terminals are installed, wherein the first and second connection terminals are disposed between an input terminal portion and an output terminal portion and connected, respectively, to a neutral point terminal and a phase voltage terminal; and a leakage preventing conductor that is electrically connected to the first connection terminal connected to the neutral point terminal and that is formed in a shape where the side and the upper part of the connection terminal block are surrounded, so as to enable only the current, generated in the phase voltage terminal, to flow to the neutral point terminal surrounding only the current.

As illustrated in a representative figure, a neutral point terminal N of three-phase power is not grounded so that a closed circuit is not formed, where the leakage current caused by the electric leakage may flows. Thus, the Korean Patent Registration No. 1197414 has a structure where the leakage current cannot flow from the conductor to the earth, etc., in any form. Also, although a passage is formed, where the neutral point of the three-phase power is grounded and where the leakage current flows, the current flowing through the neutral point is very low when the three-phase power is electrically balanced, but very high when the three-phase power is electrically unbalanced, so that there is no structure for shielding the current generated through the neutral point, and thereby the leakage current cannot help but flow.

Moreover, due to the liquid with conductivity filled in between a phase voltage terminal and a neutral point terminal within very narrow space in an apparatus for preventing a leakage current, the resistance may become very low, and thus the electric current rapidly rises to increase its absolute value in dividing into a neutral point current and a ground current. The resultant rise in the leakage current has a limit not capable of being prevented by the apparatus of the Korean Patent Registration No. 1197414.

In other words, the ground voltage of the neutral point terminal is very low in a case where the three-phase electric power is electrically unbalanced; however, the ground voltage increases in a case where the three-phase power is electrically unbalanced, a case where there is wire impedance because a length of a wire is long, or a case where the ground resistance of the neutral point has a big ground resistance caused by the earth or materials for the building. Thus, according to this related art, the leakage current generated in the phase voltage terminal may flow into the neutral point terminal, but there may be a problem in that the leakage current generated in the neutral point terminal flows into the earth, and thus, it is not capable of preventing an electric shock accident.

In addition, this related art discloses a detailed technology only about composition of a complex automatic system for automatically finding a phase voltage terminal and a neutral point terminal, and also describes only that one found terminal is connected to the phase voltage terminal and the other found terminal is connected to the neutral point terminal that surrounds the phase voltage terminal. However, bases about which reason does not cause the leakage are not provided, thus there are difficulties to apply it in reality.

Additionally, the automatic system for automatically finding a phase voltage terminal and a neutral point terminal has a complex composition, its product lifespan is short, and has shortcomings in the limited application in reality. Furthermore, this related art uses electrodes, which surround a connection terminal block and are connected to the neutral point terminal, thus its composition is complex and there are difficulties in being applied to small outlets, etc.

Similarly, this related art discloses a technology of preventing a leakage current, but not the limit of an interphase current.

### SUMMARY

The following description relates to an apparatus, with a simple structure and simple installation, for preventing an electric shock and limiting a rapidly increasing current of electrical installations so as to overcome problems mentioned above.

Provided is an apparatus for preventing an electric shock and limiting a short circuit current of a new structure that has a high effect on the electric shock prevention and limits a rapidly increasing current within electrical installations.

Provided is an apparatus for preventing an electric shock and a short circuit current that may be applied to various application fields, such as small outlets or outdoor streetlights.

In one general aspect, an apparatus for limiting an interphase current and a leakage current of flooded electrical installations is connected to a power distribution path into electrical installations, and prevents an electric shock when the electrical installations or other electrical installations electrically connected and placed in proximity to the electrical installations are flooded. The apparatus may include an inner phase wire, an inner neutral wire, an inner ground wire, and an insulation barrel.

The inner phase wire includes a phase wire portion, one end of which is electrically connected to a phase wire terminal that is electrically connected to a phase wire of a power distribution line, and the other end of which is electrically connected to the electrical installations, wherein the phase wire portion is not surrounded with an insulator. The inner neutral wire includes a barrel-shaped wire, one end of which is electrically connected to a neutral wire terminal that is electrically connected to a neutral wire of the power distribution line, and the other end of which is electrically connected to the electrical installations, wherein the barrel-shaped wire is made of a conductor material and surrounds the phase wire portion. The inner ground wire which includes a housing ground, one end of which is electrically connected to a ground wire terminal that is electrically connected to a ground wire of the power distribution line, and the other end of which is electrically connected to the electrical installations, wherein the housing ground comprises ground wirings inside an inner circumference of a housing that is formed with an insulator and surrounds the barrel-shaped wire. The insulation barrel is interposed between the inner phase wire and the barrel-shaped wire, and surrounds the inner phase wire.

The barrel-shaped wire may be extended longer than both ends of the phase wire portion towards both directions; the insulation barrel may be extended longer than both ends of the phase wire portion and the barrel-shaped wire towards both directions; and the housing ground may be extended longer than both ends of the barrel-shaped wire towards both directions.

The apparatus may further include a terminal connection checking circuit to be electrically connected between the neutral wire terminal and the ground wire terminal, and to include a resistance and an LED that are connected in series therebetween.

An interphase current is limited by increasing resistance between the phase wire portion and the barrel-shaped wire, by adjusting a length of the insulation barrel to lengthen a passage length between the inner phase wire and the inner neutral wire or by adjusting an area of the phase wire portion.

A leakage current is limited by allowing a current that flows through the barrel-shaped wire to pass through the inner ground wire via the ground wirings of the housing ground and flow out to the earth, wherein the current that flows through the barrel-shaped wire is collection of a limited interphase current and the current flowing from an electric load to the inner neutral wire.

Other features and aspects may be apparent from the following detailed description, the drawings, and the claims.

### BRIEF DESCRIPTION OF THE DRAWINGS

FIG. 1 is a diagram illustrating an apparatus for limiting an interphase current and a leakage current of flooded electrical installations according to an exemplary embodiment.

FIG. 2A is another diagram illustrating an apparatus for limiting an interphase current and a leakage current of flooded electrical installations according to an exemplary embodiment.

FIG. 2B is a diagram illustrating equivalent circuits of FIG. 2A.

FIG. 3A is a diagram illustrating a case where a human approaches a flooded apparatus for limiting an interphase current and a leakage current of flooded electrical installations according to an exemplary embodiment.

FIG. 3B is a diagram illustrating equivalent circuits of FIG. 3A.

FIG. 4 is a diagram illustrating a condition for experimenting on an effect of preventing an electric shock when an apparatus for limiting an interphase current and a leakage current of flooded electrical installations according to an exemplary embodiment is flooded.

FIG. 5 is a diagram illustrating an example of a human body contact surface of FIG. 4.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

First, theoretical bases and terms of an apparatus for limiting an interphase current and a leakage current of flooded electrical installations according to an exemplary embodiment are defined.

It seems that there is no electric charge because the amount of positive charges is the same as negative charges in equilibrium state in the natural world. However, it seems that the electric charge Q has been generated once force is added to an atom to be divided into a positive charge and a negative charge.

An electric field E is where the applied energy is transformed into electric energy around the electric charge and where the electric energy is distributed when the electric charge appears after force is added to an atom. Here, the electric field is a vector generated from the positive charge and heading for the negative charge.

A magnetic field H is where the applied energy is distributed as a magnetic energy around the current when power is added to an electric charge to be moved (i.e., when becoming an electric current). Here, the magnetic field is a vector rotating around the current.

The electric field and the magnetic field are necessarily generated together. That is, the magnetic field is generated by the electric field, or vice versa, which are electro-magnetic phenomena. Here, the electric field and the magnetic field have vectors perpendicular to each other.

A direct current or a current with a low frequency (some Hz or some KHz) may be construed as an electrostatic field or a magnetostatic field. However, a current with a high frequency of MHz or GHz band, etc. is required to be construed as electromagnetism.

A current density J is defined with a conductivity σ of an electric field E and the surrounding media, and has the following relation.

J=σE [Equation 1]

(wherein J and E are the vector quantities)

Here, a direction of the current density is the same as a vector direction of the electric field. An integral of the current density is a current I.

Resistance R of a passage where a current flows has the following relations with regard to a length l and a cross-sectional area S of the passage.

$$R = \frac{l}{σ S} \qquad [ Equation 2 ]$$

The current flowing according to the resistance has the following relations with voltage.

$$I = \frac{V}{R} \qquad [ Equation 3 ]$$

Thus, making the length of the passage longer or the area smaller to increase the resistance may limit the current.

Alternating current (AC) power generated in a power plant is three electric power (three-phase electric power) each with a phase difference of 120° (in total, 360°) in the electric space.

Generally, in a power distribution line of a three-phase four-wire system, one of the three-phase electric power is selected (single-phase electric power) and a common line is shared (a neutral wire).

In the neutral wire, three currents flowing in the three-phase electric power flows in common. However, the three currents each have an electric phase difference of 120°.

Here, if the three currents are identical (if the identical load is applied to the three phases), a vector sum of the three currents is 0, which seems as if the current does not flow.

However, since it is difficult for the identical load to be applied to the three phases so that the three currents are not identical, the vector sum of the three currents may not be zero. That is, it appears that the current is flowing in the neutral wire.

In other words, the three-phase AC circuits are star-connected in the power distribution line so that each lead end of the three single-phase systems forms one neutral point. When the loads of the three single-phase systems are balanced, there is no current flowing in the neutral wire. However, mostly the unbalanced loads are connected, and in such a case, a neutral wire current smaller than a line current may flow.

A phase wire and the neutral wire are made of conductors with less resistance; however, their length is long and their lines are arranged curvedly so that they have their own impedance.

A ground wire indicates a line connected to the ground or earth.

A leakage current indicates a current flowing through other passages except the phase wire or the neutral wire; and a ground fault current or an earth current indicates a current flowing because of small resistance between the phase wire and the ground/earth, or between the neutral wire and the ground/earth.

An electric shock is an accident that occurs due to a current flowing to the earth by passing through a human body (which has high conductivity) from the phase wire or the neutral wire. The leakage current becomes the earth current by flowing to the earth through the human body so as to cause the electric shock.

An interphase current indicates a current between one phase and the neutral wire. Since an electric shock accident may occur if the interphase current flows into a human body through the water because of the flooding, etc., the interphase current may also cause the electric shock as the leakage current.

In the present disclosure, an electric terminal apparatus for preventing a leakage current and limiting an interphase current is disclosed with reference to the above-mentioned electric items as theoretical bases.

Hereinafter, an exemplary embodiment is described in detail with reference to attached figures. First, in adding the reference numerals to components for each figure, even if the same components are marked in the different figures, the figures may have the identical numerals with regard to the same components as much as possible. Also, descriptions of well-known functions and constructions may be omitted for increased clarity and conciseness. Accordingly, various changes, modifications, and equivalents of the methods, apparatuses, and/or systems described herein will be suggested to those of ordinary skill in the art.

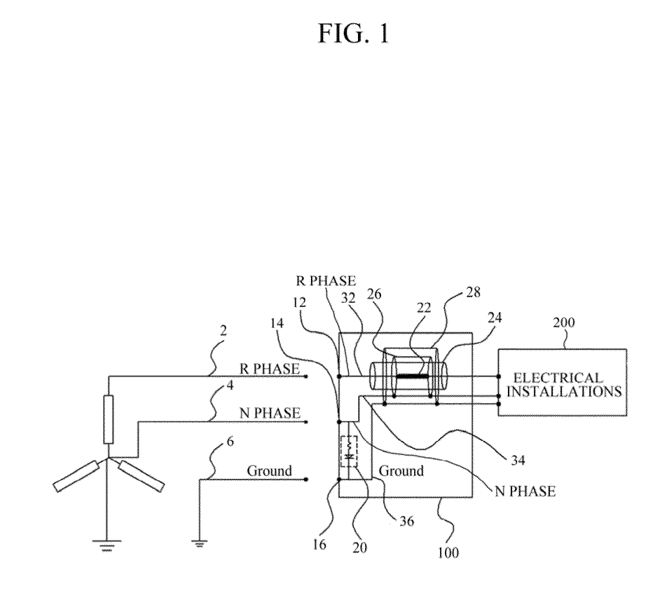

FIG. 1 is a diagram illustrating an apparatus for limiting an interphase current and a leakage current of flooded electrical installations according to an exemplary embodiment.

The apparatus for limiting an interphase current and a leakage current of flooded electrical installations according to an exemplary embodiment roughly includes four function portions with reference to FIG. 1.

(1) Inducing a Right Connection of an Electric Terminal and a Power Line

A phase wire 2 and a neutral wire 4 are required to be distinguished so as to be correctly connected to a phase wire terminal 12 and a neutral wire terminal 14 of an electric terminal 100 according to an exemplary embodiment.

To this end, a terminal connection checking circuit 20 is connected between the neutral wire terminal 14 and a ground wire terminal 16 in an entrance of the electric terminal 100. The terminal connection checking circuit 20 has an extremely simple structure where resistance and an LED are connected in series.

If the phase wire 2 of a power line is connected to the neutral wire terminal 14 of the electric terminal 100, the LED of the terminal connection checking circuit 20 is turned on so as to show that the terminal has been connected wrongly. However, if the neutral wire 4 of the power line is connected to the neutral wire terminal 14 of the electric terminal 100, the LED is not turned on so that it is determined that the terminal has been connected properly.

A ground wire terminal 16 of the electric terminal 100 is connected to a ground wire 6.

(2) Generation of an Interphase Current

An inner phase wire 32, an inner neutral wire 34, and an inner ground wire 36 are defined inside the electric terminal 100 to distinguish them from the phase wire 2, the neutral wire 4, and the ground wire 6 of a power distribution line.

The inner phase wire 32 includes the phase wire terminal 12 on one end, and the other end is electrically connected to electrical installations 200.

The inner neutral wire 34 includes the neutral wire terminal 14 on one end, and the other end is electrically connected to electrical installations 200.

The inner ground wire 36 includes the ground wire terminal 16 on one end, and the other end is electrically connected to electrical installations 200.

The inner phase wire 32, the inner neutral wire 34, and the inner ground wire 36 are arranged within the electric terminal 100. The following elements are arranged: a phase wire portion 22 that is not surrounded with insulators among parts of the inner phase wire 32; a barrel-shaped wire 26 that surrounds the phase wire portion 22 and is electrically connected to the inner neutral wire 34; and a housing ground 28 that surrounds the barrel-shaped wire 26 and is electrically connected to the inner ground wire 36. Here, an insulation barrel 24 is interposed between the phase wire portion 22 and the barrel-shaped wire 26.

The housing ground 28 is a housing that is basically formed with insulators, and includes the wirings, connected to be grounded, inside an inner circumference, wherein the ground wirings are electrically connected to the inner ground wire 36.

A material of the barrel-shaped wire 26 is a conductor. The barrel-shaped wire 26 and the housing ground 28 may be made of coaxial barrels (a barrel shape with an identical axis), and it is also okay not to be coaxial. The barrel-shaped wire 26 is a long tubular conductor whose cross section is a closed curve. FIG. 1 illustrates a long tube-shaped conductor (a coaxial cylinder wire) with a hollow center as an exemplary embodiment, which is not, however, limited thereto, and in case of the closed-curve shape completely covering the phase wire portion 22, the exemplary embodiment may be formed in various shapes, e.g., a polygonal barrel, a concave polygonal barrel, and an oval barrel, etc.

The phase wire portion 22 is inserted into the inside of the barrel-shaped wire 26, and may be a long tubular conductor with various cross-sectional shapes or a stuffed stick-shaped conductor. However, the exemplary embodiment is not limited thereto and may be formed in a polygonal tubular shape or a stuffed polygonal stick shape.

The barrel-shaped wire 26 surrounds the phase wire portion 22 that is not coated with insulators and is exposed, and is electrically connected to the inner neutral wire 34. Here, it is desirable that the height (length) of the barrel-shaped wire 26 is the same as the phase wire portion 22 or is extended longer than both ends of the phase wire portion 22 towards both directions.

The housing ground 28 surrounds the barrel-shaped wire 26 and is electrically connected to the inner ground wire 36. Here, it is desirable that the height (length) of the housing ground 28 is the same as the barrel-shaped wire 26 or is extended longer than both ends of the barrel-shaped wire 26 towards both directions.

Theoretically, all the electric field, which is started and diverged from the phase wire portion 22, ends at the barrel-shaped wire 26 connected to the inner neutral wire 34 and does not flow out to the outside. In addition, if the three-phase power is unbalanced, a current may flow even in the inner neutral wire 34, and a part of the electric field started from the barrel-shaped wire 26 connected to the inner neutral wire 34 goes to the phase wire portion 22 and the rest goes to housing ground 28 connected to the inner ground wire 36, and thus, there is no electric field flowing outside. If there is no electric field flowing outside, the interphase current is formed by the current obtained after the current density is integrated by Equation 1.

Practically, a system is housed with the housing ground 28 which is an insulator surrounding the inner neutral wire 34, and the inner ground wire 36 is connected to the housing ground 28.

(3) Limit of an Interphase Current

The insulation barrel 24 is interposed between the phase wire portion 22 and the barrel-shaped wire 26. Here, the height (length) of the insulation barrel 24 is the same as the phase wire portion 22 and the barrel-shaped wire 26, or is formed to be extended longer than both ends of the phase wire portion 22 and the barrel-shaped wire 26. Desirably, the insulation barrel 24 is extended longer than both ends of the phase wire portion 22 to be completely inserted into the inside of the insulation barrel 24, and is extended longer than both ends of the barrel-shaped wire 26 so as to completely block between the phase wire portion 22 and the barrel-shaped wire 26. For example, the height (length) may be formed in the following order: the phase wire portion 22<the barrel-shaped wire 26<the insulation barrel 24.

The insulation barrel 24 may be formed in various barrel shapes, e.g., a cylinder, an oval barrel, or an angular barrel, etc., and be coaxial with the phase wire portion 22 and the barrel-shaped wire 26. However, the exemplary embodiment is not limited thereto and it is also possible not to be coaxial.

If seawater or fresh water that includes various minerals, etc., is filled in a narrow space between the phase wire portion 22 and the barrel-shaped wire 26 (connected to the neutral wire 4), conductivity σ may become high and the space l may become very small so that resistance R becomes very low by Equation 2, thus generating a very big interphase current as in Equation 3.

Accordingly, by filling, between the phase wire portion 22 and the barrel-shaped wire 26, the insulation barrel 24 made of insulators so as to lengthen the passage length l between the phase wire and the neutral wire by, or by properly adjusting the area S of the phase wire portion 22, which is a part where the coating of the phase wire is stripped, the resistance R may increase to the maximum to limit the interphase current.

(4) Limit of a Leakage Current

A collection of a current flowing from electric loads and the limited interphase current described in the item (3) may flow through the inner neutral line 34, and the leakage current flowing out of the housing ground 28 may flow into the earth through the ground wire so as to limit, as much as possible, the leakage current that may flow into the human body, and maintain safety.

In an exemplary embodiment, an apparatus for limiting an interphase current and a leakage current of flooded electrical installations is connected to a power transmission and distribution path to electrical installations for home use or industrial use, such as a lamp, a streetlamp, an outlet, a plug, and a motor, etc., so as to prevent an electric shock caused by the flooding of the electrical installations to which the apparatus is connected or other electrical installations located nearby and electrically connected to the electrical installations.

In an exemplary embodiment, an apparatus for limiting an interphase current and a leakage current of flooded electrical installations may be installed in a state in which the phase wire portion 22, the barrel-shaped wire 26, and the housing ground 28 stand facing each other, and it is desirable to be installed in a position lower than target electric equipment that is intended to be protected from the flooding. For example, in case of the streetlamp, a controller exposed in the lower part is installed in the waterproof space; however, if this waterproof space is filled with rainwater, etc., people nearby may be in danger of electric shock. The apparatus according to an exemplary embodiment is installed in this waterproof space to be installed at the position lower than the controller so as to be flooded earlier than a flooding time of the controller, thereby being operated first.

The phase wire portion 22 and the barrel-shaped wire 26 may be made of a material of copper (Cu), whose conductivity is good. According to an experiment, the Cu material has a great effect on the electric shock prevention compared to metal and aluminum.

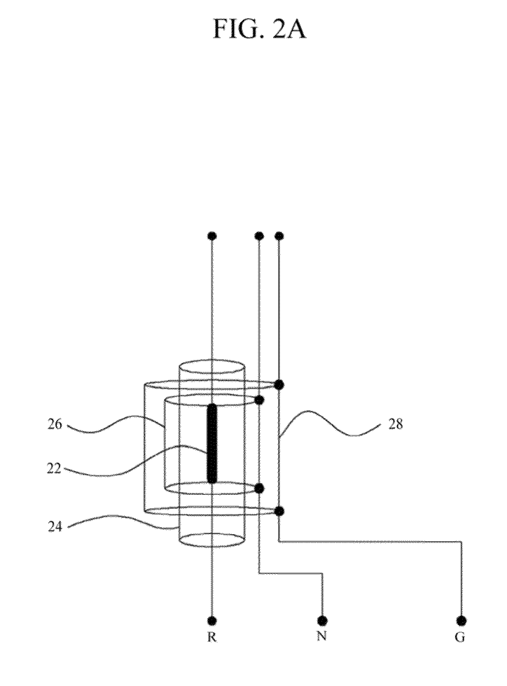

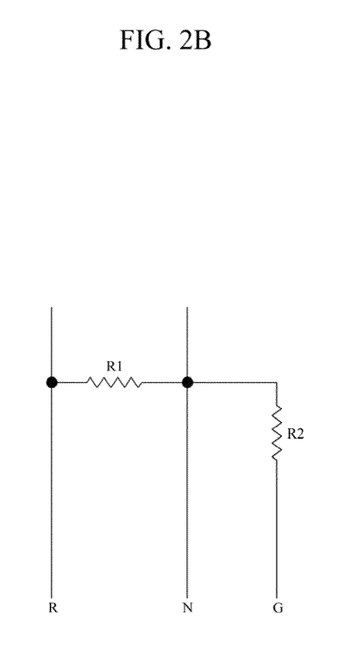

FIG. 2A is another diagram illustrating an apparatus for limiting an interphase current and a leakage current of flooded electrical installations according to an exemplary embodiment; and FIG. 2B is a diagram illustrating equivalent circuits of FIG. 2A.

Referring to FIG. 2A, resistance R1 is formed between an R phase and an N phase through water by an insulation barrel 24. In addition, resistance R2 is formed between the N phase and a G phase through the water and the earth by an insulation barrel of a housing ground 28. Here, since the N phase surrounds the R phase by a barrel-shaped wire 26 so that an electric field generated on the R phase all faces the N phase, circuits between the R phase and the N phase are formed, but circuits from the R phase to the G phase are not formed, thus only the resistance R2 is formed between the N phase and the G phase.

However, the related arts mentioned above in Description of the Related Art does not disclose an insulation barrel between the R phase and the N phase so that a current between the R phase and the N phase is short-circuited or extremely low resistance is formed, then an extremely large interphase current is generated, and an absolute value of the current that will be described below in a current distribution circuit becomes large, thus not capable of guaranteeing the security of a leakage current.

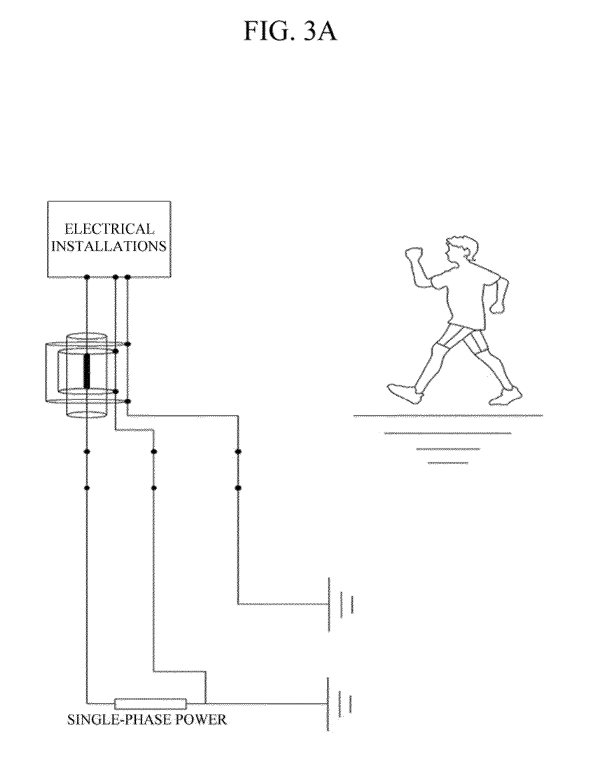

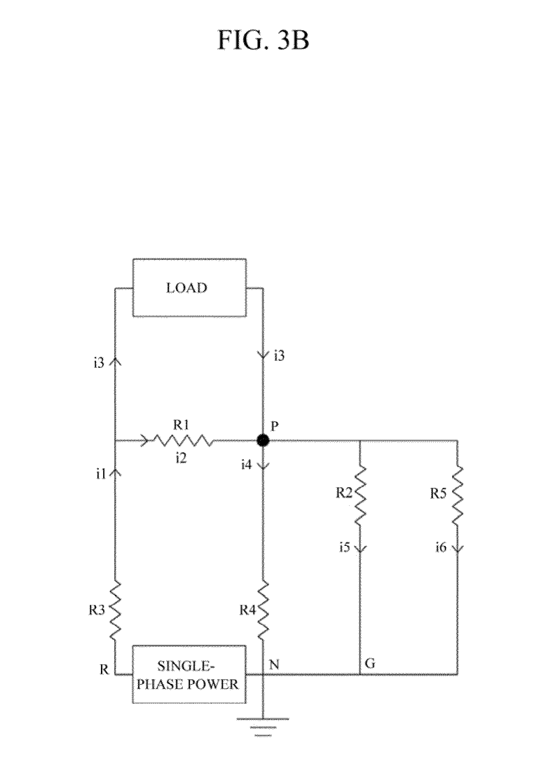

FIG. 3A is a diagram illustrating a case where a human approaches flooded apparatus for limiting an interphase current and a leakage current of flooded electrical installations according to an exemplary embodiment; and FIG. 3B is a diagram illustrating equivalent circuits of FIG. 3A.

In FIG. 3B, if an electric wire becomes longer (mostly a power distribution line actually installed is long), R3 and R4 are resistance components of an impedance composed of the resistance and the inductance, which are contained in the wire. R5 is resistance formed through human body, water resistance, and earth resistance in a case in which a person approaches.

When an apparatus for limiting an interphase current and a leakage current of flooded electrical installations according to an exemplary embodiment is installed in electrical installations and is flooded, a current i2 flows to resistance R1 formed between a phase R and a phase N, a current i3 flows through an electric load, and both are combined at a P point. The combined current is distributed into i4 on the N phase, i5 on a G phase, and a leakage current i6.

Here, the distributed currents i4, i5, and i6 are distributed as in Equation 4 below, inversely proportional to the resistance R4, R2, and R5.

$$i 4 : i 5 : i 6 = \frac{1}{R 4} : \frac{1}{R 2} : \frac{1}{R 5} \qquad [ Equation 4 ]$$

Generally, the resistance R4 on an N phase electric wire is very small, and thus, most of the current is i4. In addition, R2 and R5 have a relatively large value compared to R4, so that i5 and i6 become small so as to limit the leakage current.

In the present disclosure, a core for limiting the leakage current is as follows:

(1) If an insulation barrel is placed between the R phase and the N phase to make the resistance R1 big and the current i2 small, currents combined at the P point becomes small (i.e., reducing an absolute value of the distributed current).

(2) For the distribution (i4, i5, and i6) of the currents combined at the P point, the size of the current i6 may be reduced by properly adjusting the size of the resistance R2.

However, in the second related art mentioned above in Description of the Related Art,

(1) there is no insulation barrel interposed so that the resistance R1 is very small and the current i2 becomes very big, thereby greatly increasing an absolute value of the combined current.

(2) it is determined or not mentioned that there is no resistance in the electric wires of the R phase and the N phase, thus it is considered that most of the combined current flows to the N phase, which is a serious error.

(3) even in a state where the leakage current i6 flows, if the combined current is distributed only into i5 and i6, the leakage current i6 may be limited to the most; however, in the second related art, when an accident in which the neutral wire is disconnected occurs, there is no passage where the current of i4 flows so that all the currents may flow into i6, which cause a big accident.

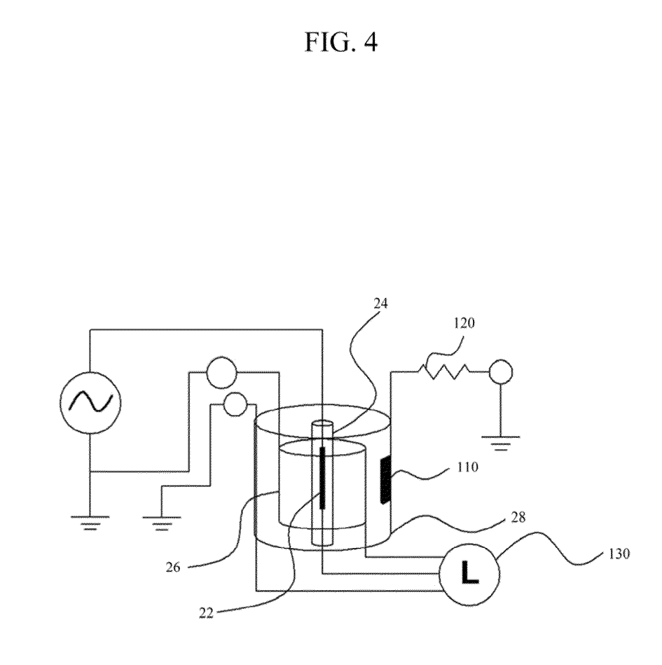

FIG. 4 is a diagram illustrating a condition for experimenting on an effect of preventing an electric shock when an apparatus for limiting an interphase current and a leakage current of flooded electrical installations according to an exemplary embodiment is flooded.

By using an experimental design as FIG. 4, a size of a leakage current is measured in accordance with an arrangement, size, and space of a phase wire and a neutral wire of an electric terminal 100 according to an exemplary embodiment.

As illustrated in FIG. 4, an electric insulation tube (an insulation barrel 24) is placed around a phase wire portion 22, and a neutral wire tube (a barrel-shaped wire 26) is placed outside. Outside the neutral wire tube 26, an electrical box tube (a housing ground 28) of the electric terminal is placed.

The electric terminal 100 is designed in a structure where the phase wire is connected to the phase wire portion 22, the neutral wire is connected to the neutral wire tube 26, and a protection ground wire is connected to the electrical box tube 28 of the electric terminal. An electric load 130 is set to 6 W.

If the phase wire portion 22 and the neutral wire tube 26 are flooded, the insulation is destroyed so that a ground leakage current and an external leakage current are generated. [At this time, by limiting the ground leakage current (under 15 mA) and preventing a circuit breaker from being shut off, electric devices may normally operate even when flooded. Also, limiting the leakage current (under 10 mA) prevents an election shock.

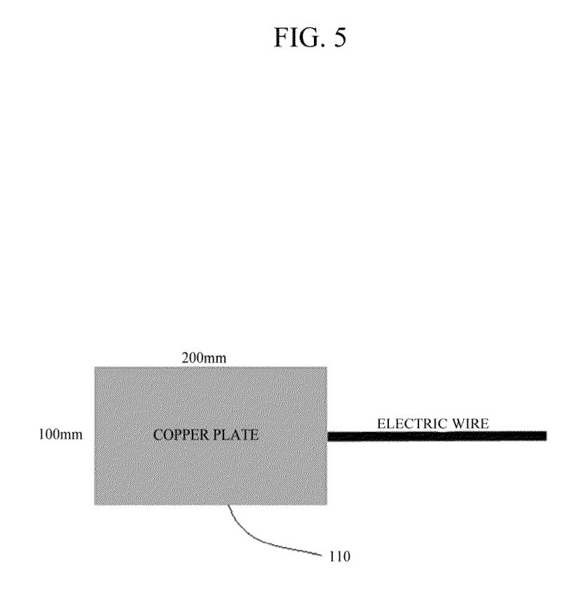

For measurement of the leakage current, the electric terminal 100 includes a human body contact surface 110 as illustrated in FIG. 5, and replacement resistance 120 replaceable with resistance of the human body is set to 1 kΩ (common standard criteria with respect to an electric and mechanical security). The human body contact surface is made of a width 200 mm and a height 100 mm of a copper plate.

Resistance R between the phase wire portion 22 and the neutral wire tube 26 is changed by adjusting a surface area S of the phase wire portion 22, and adjusting a length l by putting the electric insulation tube 24 between the phase wire portion 22 and the neutral wire tube 26

$$( R = \frac{l}{σ S} ) .$$

Table 1 is arranged as below by using an ampere meter A1 to measure a current flowing in the neutral wire, using an ampere meter A2 to measure a ground current, and using A3 to measure a leakage current. Here, an interphase current is a value acquired after a load current is subtracted from a value of the ampere meter (A1+A2+A3).

TABLE 1

| L (mm) | d (mm) | I (mm) | A1 (mA) | A2 (mA) | A3 (mA) |
|---|---|---|---|---|---|
| 75 | 50 | 35 | 13 | 0 | 0 |
| | | 50 | 22 | 1 | 0 |
| | | 75 | 44 | 2 | 0 |
| | 75 | 35 | 12 | 0 | 0 |
| | | 50 | 22 | 0 | 0 |
| | | 75 | 62 | 2 | 1 |
| | 100 | 35 | 14 | 0 | 0 |
| | | 50 | 20 | 0 | 0 |
| | | 75 | 72 | 2.2 | 1 |
| 100 | 50 | 35 | 12 | 0 | 0 |
| | | 50 | 40 | 0 | 0 |
| | | 75 | 42 | 1 | 0 |
| | | 100 | 42 | 2 | 1 |
| | 75 | 35 | 12 | 0 | 0 |
| | | 50 | 14 | 0 | 0 |
| | | 75 | 22 | 0 | 0 |
| | | 100 | 46 | 2 | 1 |
| | 100 | 35 | 13 | 0 | 0 |
| | | 50 | 18 | 0 | 0 |
| | | 75 | 24 | 0 | 0 |
| | | 100 | 46 | 1 | 1 |
| 150 | 50 | 35 | 12 | 0 | 0 |
| | | 50 | 12 | 0 | 0 |
| | | 75 | 16 | 0 | 0 |
| | | 100 | 22 | 0 | 0 |
| | | 150 | 36 | 1 | 1 |
| | 75 | 35 | 12 | 0 | 0 |
| | | 50 | 12 | 0 | 0 |
| | | 75 | 12 | 0 | 0 |
| | | 100 | 20 | 0 | 0 |
| | | 150 | 52 | 1 | 0 |
| | 100 | 35 | 12 | 0 | 0 |
| | | 50 | 12 | 0 | 0 |
| | | 75 | 18 | 0 | 0 |
| | | 100 | 22 | 0 | 0 |
| | | 150 | 52 | 1 | 0 |

In Table 1, L indicates a height of a copper tube selected as the neutral wire tube 26; d indicates a space between the neutral wire tube 26 and the phase wire portion 22, and I indicates a length of the phase wire portion 22. The diameter of the phase wire portion 22 is set to 6 mm equally.

Also, when the neutral wire is disconnected by an accident, etc., most of the currents flow as a ground leakage current, and the external leakage current is limited within a secure range. Such an experiment result is arranged in Table 2 below.

TABLE 2

| L (mm) | d (mm) | I (mm) | A3 (mA) | A2 (mA) |
|---|---|---|---|---|
| 75 | 50 | 35 | 12 | 0 |
| | | 50 | 22 | 1 |
| | | 75 | 44 | 2 |
| | 75 | 35 | 12 | 0 |
| | | 50 | 22 | 0 |
| | | 75 | 62 | 2 |
| | 100 | 35 | 14 | 0 |
| | | 50 | 20 | 0 |
| | | 75 | 72 | 2.2 |
| 100 | 50 | 35 | 12 | 0 |
| | | 50 | 40 | 0 |
| | | 75 | 42 | 1 |
| | | 100 | 42 | 2 |
| | 75 | 35 | 12 | 0 |
| | | 50 | 14 | 0 |
| | | 75 | 22 | 0 |
| | | 100 | 46 | 2 |
| | 100 | 35 | 12 | 0 |
| | | 50 | 18 | 0 |
| | | 75 | 24 | 0 |
| | | 100 | 46 | 1 |
| 150 | 50 | 35 | 12 | 0 |
| | | 50 | 12 | 0 |
| | | 75 | 16 | 0 |
| | | 100 | 22 | 0 |
| | | 150 | 36 | 1 |
| | 75 | 35 | 12 | 0 |
| | | 50 | 12 | 0 |
| | | 75 | 12 | 0 |
| | | 100 | 20 | 0 |
| | | 150 | 52 | 1 |
| | 100 | 35 | 12 | 0 |
| | | 50 | 12 | 0 |
| | | 75 | 18 | 0 |
| | | 100 | 22 | 0 |
| | | 150 | 52 | 1 |

With reference to experiment data according to Table 1 and Table 2, if the electric terminal is flooded with the same structure as illustrated in FIG. 4, it may be determined that the current is not diverged from an active electric line towards the electrical box tube 28 of the electric terminal, and mostly goes toward the neutral wire.

Also, it may be checked that the size of the ground leakage current may be limited by changing the electric resistance between the active electric line and the neutral wire.

A current generated from the insulation damage caused by the flooding is mostly induced to a neutral wire and a protection ground wire, and an external leakage current is very limited. When complex accidents occur, such as the flooding of an electric terminal and the disconnection of the neutral wire according to an exemplary embodiment, the current flows to the protection ground wire, and the external leakage current may be within a secure current range. Through such an experiment result, it may be known that the electric shock prevention is possible regardless of criteria of each component included in the electric terminal, such as L that is a height of the copper tube selected as the neutral wire tube 26, d that is a space between the neutral wire tube 26 and an active electric line connection portion 22, and I that is a length of the active electric line connection portion 22.

According to an exemplary embodiment, by a simple structure, an interphase current and a leakage current flowing outside are minimized when flooded, thus in reality reducing a current flowing to a human body contacted to nearby leaked electricity.

According to an exemplary embodiment, the length of an insulation barrel inserted between an inner phase wire and an inner neutral wire is adjusted to increase the length of the passage between the inner phase wire and the inner neutral wire, or the area of the phase wire portion is adjusted to increase resistance between the phase wire portion and the barrel-shaped wire, thus limiting the interphase current.

Moreover, according to an exemplary embodiment, a leakage current is limited by allowing a current that flows through the barrel-shaped wire to pass through the inner ground wire via the ground wirings of the housing ground and flow out to the earth, wherein the current that flows through the barrel-shaped wire is collection of a limited interphase current and the current flowing from an electric load to the inner neutral wire.

Furthermore, according to an exemplary embodiment, a terminal connection checking circuit is connected in an extremely simple structure in which resistance and an LED are connected in series, between a neutral wire terminal and a ground wire terminal of the entrance of an electric terminal, thus inducing the correct connection between the terminals of the electric terminal and the electric wire.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for limiting an interphase current and a leakage current of flooded electrical installations, wherein the apparatus is connected to a power distribution path into electrical installations, and prevents an electric shock when the electrical installations or other electrical installations electrically connected and placed in proximity to the electrical installations are flooded, the apparatus comprising:
an inner phase wire which comprises a phase wire portion, one end of which is electrically connected to a phase wire terminal that is electrically connected to a phase wire of a power distribution line, and the other end of which is electrically connected to the electrical installations, wherein the phase wire portion is not surrounded with an insulator;
an inner neutral wire which comprises a barrel-shaped wire, one end of which is electrically connected to a neutral wire terminal that is electrically connected to a neutral wire of the power distribution line, and the other end of which is electrically connected to the electrical installations, wherein the barrel-shaped wire is made of a conductor material and surrounds the phase wire portion;
an inner ground wire which comprises a housing ground, one end of which is electrically connected to a ground wire terminal that is electrically connected to a ground wire of the power distribution line, and the other end of which is electrically connected to the electrical installations, wherein the housing ground comprises ground wirings inside an inner circumference of a housing that is formed with an insulator and surrounds the barrel-shaped wire; and
an insulation barrel configured to be interposed between the inner phase wire and the barrel-shaped wire and to surround the inner phase wire.

2. The apparatus of claim 1, wherein:
the barrel-shaped wire is extended longer than both ends of the phase wire portion towards both directions;
the insulation barrel is extended longer than both ends of the phase wire portion and the barrel-shaped wire towards both directions; and
the housing ground is extended longer than both ends of the barrel-shaped wire towards both directions.

3. The apparatus of claim 1, further comprising:
a terminal connection checking circuit configured to be electrically connected between the neutral wire terminal and the ground wire terminal, and comprise a resistance and an LED that are connected in series therebetween.

4. The apparatus of claim 1, wherein an interphase current is limited by increasing resistance between the phase wire portion and the barrel-shaped wire, by adjusting a length of the insulation barrel to lengthen a passage length between the inner phase wire and the inner neutral wire or by adjusting an area of the phase wire portion.

5. The apparatus of claim 4, wherein a leakage current is limited by allowing a current that flows through the barrel-shaped wire to pass through the inner ground wire via the ground wirings of the housing ground and flow out to the earth, wherein the current that flows through the barrel-shaped wire is collection of a limited interphase current and the current flowing from an electric load to the inner neutral wire.
